(19) United States
(12) Patent Application Publication
(10) Pub. No.: US 2008/0006010 A1
(43) Pub. Date: Jan. 10, 2008

(54) Desiccant arrangement for a computing device

(76) Inventors: Mark Lamont, Holtsville, NY (US); David M. Bauer, Head of the Harbor, NY (US); Amir Weiss, Patchogue, NY (US); Frank Gong, Syosset, NY (US); Alfred C. Henneborn, East Islip, NY (US); Chris Morris, Bentonville, AR (US)

Correspondence Address: FAY KAPLUN & MARCIN, LLP, 15O BROADWAY, SUITE 702, NEW YORK, NY, 10038, US

(21) Appl. No.: 11/482,865

(22) Filed: Jul. 7, 2006

(51) Int. Cl. B01D 50/00

(52) U.S. Cl. 55/385.6

(57) ABSTRACT

Described is a desiccant arrangement for a computing device. The computing device comprises a sealed housing, an optical element having at least one substantially flat surface internal to the sealed housing and a desiccant removing moisture from air within the sealed housing to prevent accumulation of the moisture on the at least one substantially flat surface.

### FIELD OF THE INVENTION

The present invention relates generally to desiccant arrangements for computing devices.

### BACKGROUND

Moisture may be formed in air when air temperatures change from warm to cold, or vice-versa. The moisture, in the form of condensation and/or fog, may cause components inside a computing device to short and/or become difficult to use. For example, on a bar code scanner, fog may build up on a display screen or a touch panel hindering a view of content displayed thereon. Also, fog built up on a scan window may negatively impact scanning attempts (e.g., refract a laser, blur images, etc.). Thus, there is a need to remove moisture within in computing devices.

### SUMMARY OF THE INVENTION

The present invention relates to a desiccant arrangement for a computing device. The computing device comprises a sealed housing, an optical element having at least one substantially flat surface internal to the sealed housing and a desiccant removing moisture from air within the sealed housing to prevent accumulation of the moisture on the at least one substantially flat surface.

### DESCRIPTION OF THE DRAWINGS

FIG. 1 shows an exploded view of an exemplary embodiment of a desiccant arrangement for a computing device according to the present invention.

FIG. 2 shows an assembled view of an exemplary embodiment of a desiccant arrangement for a computing device according to the present invention.

### DETAILED DESCRIPTION

The present invention may be further understood with reference to the following description and the appended drawings, wherein like elements are referred to with the same reference numerals. The present invention describes a desiccant arrangement for a computing device. The exemplary embodiments of the present invention will be described with reference to use of the desiccant arrangement in a mobile computing unit. However, those of skill in the art will understand that the desiccant arrangement of the present invention may also be utilized by stationary computing device in which condensation, moisture and/or fog may be problematic. For example, internal temperature changes within the stationary computing device may generate moisture when the stationary computing device is used in high or low temperature environments.

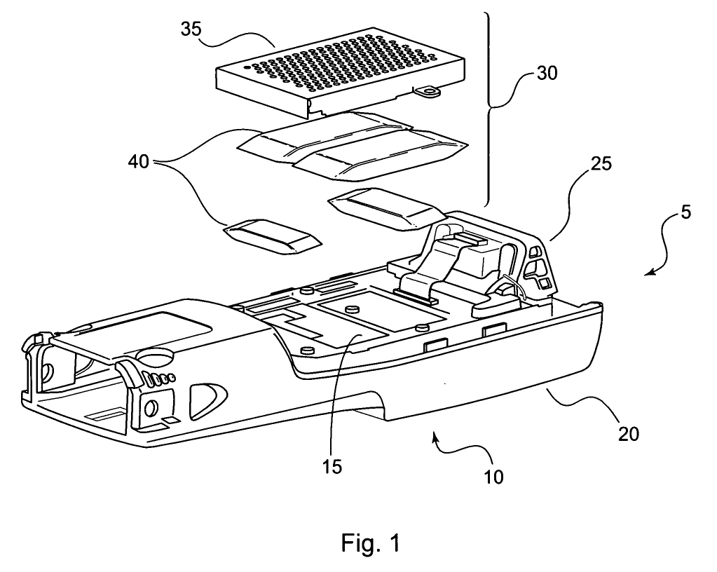

FIG. 1 shows an exemplary embodiment of a desiccant arrangement for a computing device according to the present invention. A mobile computing unit (MU) 5 comprises a sealed housing 10 which encases a printed circuit board (PCB) 15 and other internal components of the MU 5. The MU 5 may be, for example, a laser-/imager-based scanner, an RFID reader, a mobile phone, a PDA, a laptop, a tablet computer, a digital camera, a digital media player, a portable gaming console, etc. In the exemplary embodiment, the MU 5 is robust and may operate in a variety of environmental conditions without suffering a substantially noticeable degradation in performance. For example, the MU 5 may be used in both low temperature environments (e.g., cold storage, freezer applications, shipping yards, etc.) and high temperature environments (e.g., warm outdoor climates, factories, mills, etc.).

When the MU 5 is not in use, it is typically coupled to a charger located in a controlled temperature environment, e.g., a warehouse, a store room, etc. When the MU 5 is removed from the controlled temperature environment and used in the low or high temperature environment, moisture (e.g., condensation, fog, etc.) may be form in air within the housing 10 as a function of the temperature change. The moisture can negatively impact use of the MU 5 by, for example, shorting electrical components, fogging up optical elements such as a display screen 20, a touch panel, a scan window 25, a lens of an imager, a mirror, etc.

The exemplary embodiments of the present invention provides a desiccant arrangement 30 to absorb moisture in the air within the housing 10 of the MU 5. In one exemplary embodiment, the desiccant arrangement 30 comprises an enclosure 35 which encases one or more desiccants 40. The enclosure 35 may be, for example, a perforated cage allowing air to circulate through the desiccants 40 so that any moisture in the air is absorbed. Those of skill in the art will understand that the enclosure 35 may be formed from any material which is permeable to water vapor

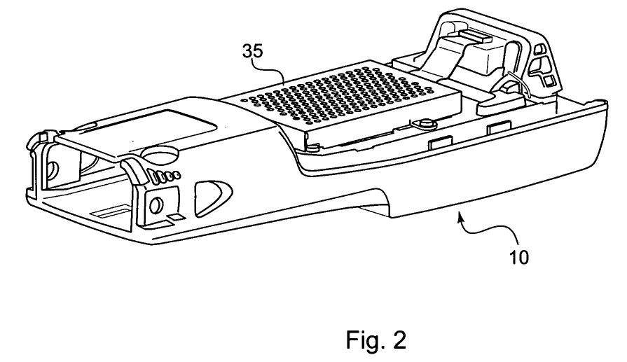

The enclosure 35 may be mounted to a main assembly stack in the housing 10 which includes the PCB 15. In this manner, the desiccants 40 may be sandwiched between the enclosure 35 and the PCB 15, as shown in FIG. 2. Preferably, the enclosure 35 is mounted adjacent the display screen 20, the scan window 25 and/or any other component of the MU 5 so that any air in the housing near these components will have the moisture removed therefrom by the desiccants 40. Situating the desiccants 40 in a single location (e.g., encased by the enclosure 35) may provide a combined absorbent effect by multiple desiccants on air circulated therethrough.

The enclosure 35 may be permanently or temporarily mounted to the main assembly stack of the MU 5. For example, an adhesive or soldering/welding may be used to affix the enclosure 35 permanently to the main assembly stack. In the alternative, the enclosure 35 may be mechanically fastened (e.g., screws) or hingedly coupled to the main assembly stack so that the enclosure 35 is temporarily or removably coupled to the main assembly stack. In this manner, the desiccants 40 may be replaced after a predetermined time period. In any embodiment, the enclosure 35 may be mechanically, chemically or electrically mounted within the housing 10 of the MU 5.

In an alternative exemplary embodiment, the desiccants 40 may be disposed individually (or in groups) in predetermined locations throughout the housing 10. In this embodiment, less space may be required than encasing all of the desiccants 40 under the enclosure 35. Thus, the desiccants 40 may be disposed in locations adjacent to components likely to be effected by the moisture, e.g., the display screen 20, the touch panel, the scan window 25, etc.

In a further exemplary embodiment, the desiccants 40 may be disposed on a door which provides access to the sealed housing 10. In this embodiment, the desiccants 40 may be easily replaced when they have become saturated.

The desiccants 40 may be comprised of any one or combination of substances that absorbs water which include, but are not limited to, silica gel, calcium sulfate, montmorillonite clay, molecular sieves, etc.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A computing device, comprising:
a sealed housing;
an optical element having at least one substantially flat surface internal to the sealed housing; and
a desiccant removing moisture from air within the sealed housing to prevent accumulation of the moisture on the at least one substantially flat surface.

2. The computing device according to claim 1, further comprising:
a perforated enclosure securing the desiccant within the sealed housing.

3. The computing device according to claim 2, further comprising:
a stack assembly, wherein the perforated enclosure is mounted to the stack assembly.

4. The computing device according to claim 1, further including at least one of a laser-based scanner, an imager-based scanner, an RFID reader, a mobile phone, a PDA, a digital camera and a digital media player.

5. The computing device according to claim 1, wherein the optical element is one of a display screen, a touch panel, a scanner exit window, a lens and a mirror.

6. The computing device according to claim 1, wherein the desiccant is at least one of silica gel, calcium sulfate, montmorillonite clay and a molecular sieve.

7. The computing device according to claim 3, wherein the enclosure is mounted to the stack assembly via one of a mechanical and a chemical coupling.

8. The computing device according to claim 7, wherein the mechanical coupling is one of a plurality of screws and a snap-fit.

9. The computing device according to claim 7, wherein the chemical coupling is an adhesive.

10. A computing device, comprising:
a stack assembly including a printed circuit board;
a perforated enclosure; and
at least one desiccant being situated within the enclosure,
wherein the enclosure is mounted to the stack assembly in such a manner that the at least one desiccant is situated between at least one inner wall of the enclosure and the printed circuit board.

11. The computing device according to claim 10, further including at least one of a display screen, a touch panel, a laser-based scanner, an imager-based scanner, an RFID reader, a mobile phone, a PDA, a digital camera and a digital media player.

12. The computing device according to claim 10, wherein the enclosure is a metal cage with a plurality of holes formed therein.

13. The computing device according to claim 10, wherein the at least one desiccant is at least one of silica gel, calcium sulfate, montmorillonite clay and a molecular sieve.

14. The computing device according to claim 10, wherein the enclosure is mounted to the board via one of a mechanical and a chemical coupling.

15. The computing device according to claim 10, further comprising:
an optical element having at least one substantially flat surface internal to the sealed housing.

16. The computing device according to claim 15, wherein the optical element is one of a display screen, a touch panel, a scanner exit window, a lens and a mirror.

17. A desiccant arrangement, comprising:
an enclosure;
at least one desiccant situated within the enclosure; and
a mounting arrangement mounting the enclosure to one of a stack assembly and a printed circuit board.

18. The desiccant arrangement according to claim 17, wherein the enclosure is a metal cage with a plurality of holes formed therein.

19. The desiccant arrangement according to claim 17, wherein the at least one desiccant is at least one of silica gel, calcium sulfate, montmorillonite clay and a molecular sieve.

20. A computing device, comprising:
a stack means including a printed circuit board;
an enclosing means; and
at least one desiccant being situated within the enclosing means,
wherein the enclosing means is mounted to the stack means in such a manner that the at least one desiccant is situated between at least one inner wall of the enclosing means and the printed circuit board.
